(19) United States
(12) Patent Application Publication
(10) Pub. No.: US 2022/0068515 A1
(43) Pub. Date: Mar. 3, 2022

(54) EXPOSURE PREVENTION APPARATUS FOR DISMANTLING HEAVY WATER REACTOR FACILITIES AND DISMANTLING METHOD OF HEAVY WATER REACTOR FACILITIES USING THE SAME

(71) Applicant: KOREA HYDRO & NUCLEAR POWER CO., LTD., Gyeongju-si (KR)

(72) Inventors: Seok-Ju HWANG, Daejeon (KR); Young Hwan HWANG, Daejeon (KR); Ju-Young YOON, Daejeon (KR); Cheon-Woo Kim, Daejeon (KR)

(21) Appl. No.: 17/422,822

(22) PCT Filed: Feb. 12, 2020
(86) PCT No.: PCT/KR2020/001959

§ 371 Date: Jul. 14, 2021

(30) Foreign Application Priority Data
Mar. 4, 2019 (KR) 10-2019-0024790

(51) Int. Cl. G21F 3/00; G01T 1/02; G21D 1/00; G08B 21/18

(52) U.S. Cl. CPC G21F 3/00; G08B 21/182; G21D 1/003; G01T 1/02

(57) ABSTRACT

An exposure prevention device for dismantling a heavy water reactor facility according to an embodiment includes: a shielding film that covers a front surface and a rear surface of a heavy water facility including a calandria and a calandria vault that accommodates the calandria; a plurality of radiation measuring instruments installed in the shielding film; and a motion detector installed in the shielding film.

### TECHNICAL FIELD

The present invention relates to an exposure prevention device for dismantling a heavy water reactor facility, and a method for dismantling a heavy water reactor facility using the same.

### BACKGROUND ART

In general, among the nuclear facilities used for nuclear power generation, a heavy water reactor facility includes a calandria and a calandria vault receiving the calandria therein.

As a nuclear fuel injection cylinder for a nuclear reactor of a heavy water reactor type of nuclear power plant, the calandria has a cylindrical pipe structure that injects nuclear fuel during normal operation of the power plant and discharges a bundle of combusted nuclear fuel.

Since front and rear surfaces of the calandria are exposed to the outside for nuclear fuel replacement, there is a risk of worker exposure and radiation leakage when dismantling the calandria and calandria vaults, which are highly radioactive structures.

### DISCLOSURE

### Technical Problem

The present embodiment relates to an exposure prevention device for dismantling of a heavy water reactor facility that can reduce the exposure of workers positioned around a calandria and promote industry safety when the heavy water reactor facility is dismantled, and a method of dismantling the heavy water reactor facility using the same.

### Technical Solution

An exposure prevention device for dismantling a heavy water reactor facility according to an embodiment includes: a shielding film that covers a front surface and a rear surface of a heavy water facility including a calandria and a calandria vault that accommodates the calandria; a plurality of radiation measuring instruments installed in the shielding film; and a motion detector installed in the shielding film.

The exposure prevention device for dismantling the heavy water reactor facility may further include a dose display unit that is provided in the shielding film and displays a dose determined by the radiation measuring instruments.

The exposure prevention device for dismantling the heavy water reactor facility may further include a warning unit that is connected to the motion detector, and warns a worker of a situation detected by the motion detector.

In addition, a method for dismantling a heavy water reactor facility that includes a calandria including a main shell and a sub shell, a calandria vault that receives the calandria therein, a reactor pipe including a pressure tube that horizontally penetrates the calandria, a calandria tube that surrounds the pressure tube, and a cover assembly that is provided in the calandria vault, includes: dismantling the reactor pipe provided in the calandria; installing an exposure preventing device in a front and a rear of the calandria vault; dismantling the cover assembly that covers the calandria; dismantling the calandria; and dismantling the calandria vault.

The calandria may further include an end shield that is connected to the sub shell, and the dismantling of the reactor pipe may include removing a coolant feeder that supplies a coolant to the calandria, removing an end fitting part connected to the end shield, and removing the pressure tube and the calandria tube.

The cover assembly comprises a reactivity mechanism deck that is supported by an upper portion of the calandria vault and covers the calandria, an upper guide tube that is vertically connected to the calandria, a side guide tube that is horizontally connected to the calandria, a pressure relief pipe connected to the upper portion of the calandria, and a moderator pipe that is connected to a lower portion and a side surface of the calandria and through which a moderator flows, and the dismantling the cover assembly may include dismantling the upper guide tube, dismantling the side guide tube, removing the pressure relief pipe, removing the moderator pipe, and removing the reactivity mechanism deck

The exposure prevention device may include a shielding film that covers opposite sides of the calandria vault, a plurality of radiation measuring instruments installed in the shielding film, and a motion detector installed in the shielding film.

A dose by the radiation measuring instruments may be displayed by using a dose display unit installed in the shielding film.

A situation detected by the motion detector may be warned to a worker by using a warning unit connected to the motion detector.

The dismantling the calandria may include: supporting the main shell of the calandria by inserting a transfer device to the inside of the calandria vault through the upper portion of the calandria vault; cutting between the main shell and the sub shell of the calandria by using a cutting means; and drawing out the main shell of the calandria from the inside of the calandria vault to the outside of the calandria vault by using the transfer device.

### Advantageous Effects

According to an embodiment, the exposure prevention device for dismantling of the heavy water reactor facility is formed to cover the front and rear surfaces of the calandria, and thus exposure of workers and a radiation leakage by the front and rear surfaces of the calandria exposed to the outside for nuclear fuel replacement problems can be minimized.

### DESCRIPTION OF THE DRAWINGS

FIG. 1 is a schematic perspective view of a heavy water reactor facility according to an embodiment.

FIG. 2 is a schematic cross-sectional view of the heavy water reactor facility according to the embodiment.

FIG. 3 is an enlarged view of the part A of FIG. 2.

FIG. 4 is a top plan view of a state in which the exposure prevention apparatus for dismantling is installed in the heavy water reactor facility of a heavy water reactor according to the embodiment.

FIG. 5 is a schematic perspective view of the exposure prevention apparatus for dismantling of the heavy water reactor facility according to the embodiment.

FIG. 6 is a cross-sectional view of a state in which the exposure prevention apparatus for dismantling is installed in a front side and a rear side of the calandria vault according to the embodiment.

FIG. 7 is a flowchart of a heavy water reactor facility dismantling method of the heavy water reactor facility according to the embodiment.

### MODE FOR INVENTION

Hereinafter, the present invention will be described more fully hereinafter with reference to the accompanying drawings, in which embodiments of the invention are shown. The present invention may be implemented in several different forms and is not limited to the embodiments described herein.

In order to clearly explain the present invention, parts irrelevant to the description are omitted, and the same reference signs are used for the same or similar constituent elements throughout the specification.

In addition, since the size and thickness of each component shown in the drawings are arbitrarily indicated for convenience of explanation, the present invention is not necessarily limited to the illustrated drawings.

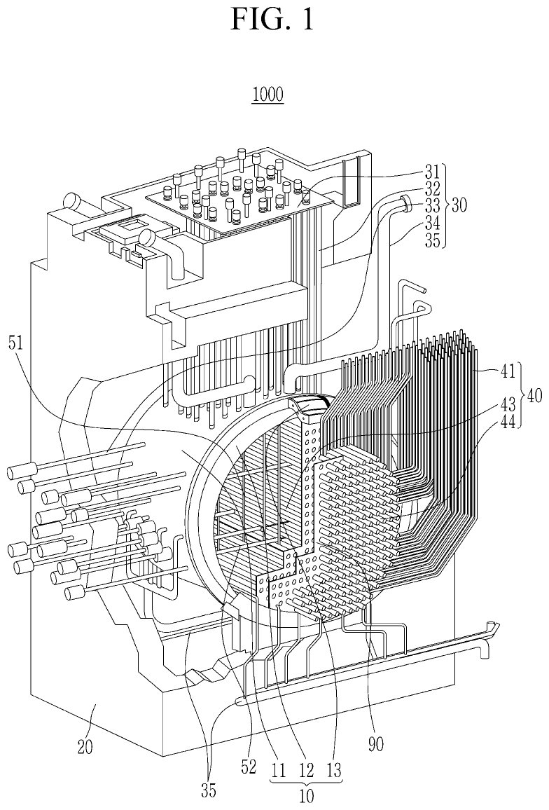

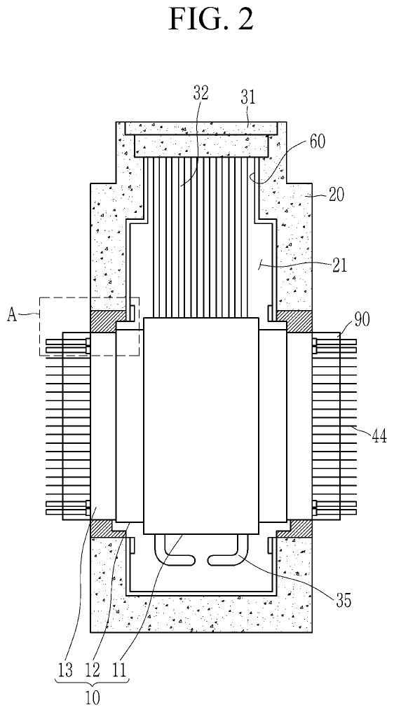

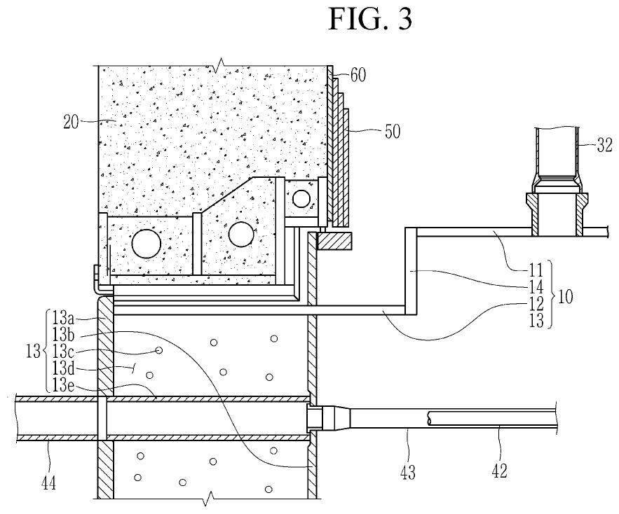

FIG. 1 is a schematic perspective view of a heavy water reactor facility according to an embodiment, FIG. 2 is a schematic side view of the heavy water reactor facility according to the embodiment, and FIG. 3 is an enlarged view of the part A of FIG. 2.

Hereinafter, a CANDU type of heavy water reactor facility including a calandria as a heavy water reactor facility will be described as an example, but the heavy water reactor facility is not limited thereto.

As shown in FIG. 1 to FIG. 3, a heavy water reactor facility 1000 includes a calandria 10, a calandria vault 20 that accommodates the calandria 10 in an interior portion 21, a cover assembly 30 that includes a reactivity mechanism deck 31 disposed in an upper portion 22 of the calandria vault 20 to cover the calandria 10, and a reactor pipe 40 installed in the calandria 10.

The calandria 10 may include a main shell 11 disposed in a center, sub shells 12 disposed at opposite ends of the main shell 11, and end shields 13 connected to the sub shells 12.

The end shield 13 may include a fueling tube sheet 13a and a calandria tube sheet 13b that face each other, and a plurality of shield balls 13c and shielding water 13d that fill between the calandria tube sheet 13b and the fueling tube sheet 13a. The shield ball 13c may be a ball made of carbon steel, and the shielding water 13d may be light water.

The shield ball 13c may be a ball made of carbon steel, and the shielding water 13d may be light water.

The cover assembly 30 may include a reactivity mechanism deck 31 that is supported by an upper portion of the calandria vault 20 and thus covers the calandria 10, an upper guide tube 32 that vertically connects the reactivity mechanism deck 31 and the calandria 10, a side guide tube 33 that is horizontally connected to the calandria 10, a pressure relief pipe 34 that is connected with the upper portion of the calandria 10 and discharges an internal pressure of the calandria 10 to the outside, and a moderator pipe 35 that is connected with a side surface and a lower portion of the calandria 10 and through which a moderator flows in and flows out. Control devices such as a control rod and an absorbent rod can be inserted into the upper guide tube 32 and the side guide tube 33.

The reactor pipe 40 may include a coolant feeder 41 that supplies a coolant to the calandria 10, a pressure tube 42 that horizontally penetrates the calandria 10, a calandria tube 43 that is connected with the end shield 13 while surrounding the pressure tube 42, and an end fitting part 44 that is connected to one side of the end shield 13. The coolant feeder 41 is connected to opposite ends of the pressure tube 42 to supply the coolant to the pressure tube 42.

The calandria tube 43 may be connected to the calandria tube sheet 13b of the end shield 13.

The upper guide tube 32 is connected with an upper end of a guide pipe 51 that is vertically disposed in the calandria 10, and the side guide tube 33 may be connected with one end of a poisonous material injection pipe 52 that is horizontally disposed in the calandria 10. The guide pipe 51 is a pipe for guiding the reactivity control and monitoring device, and the poisonous material injection pipe 52 is a pipe for injecting a poisonous material for stopping the reactor.

An insulation material 90 may be provided in a front side and a rear side of the calandria 10. The insulation material 90 may cover the surface of the end fitting part 44 exposed to the outside of the calandria 10 for nuclear fuel replacement. Such an insulation material 90 may be made of aluminum or the like, but is not limited thereto.

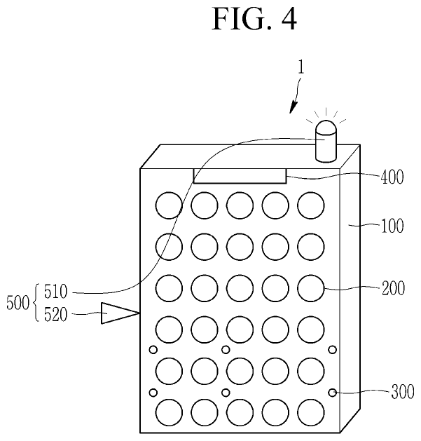

Hereinafter, an exposure prevention apparatus for dismantling a heavy water reactor facility illustrated in FIG. 1 to FIG. 3 will be described in detail with reference to FIG. 4 to FIG. 6.

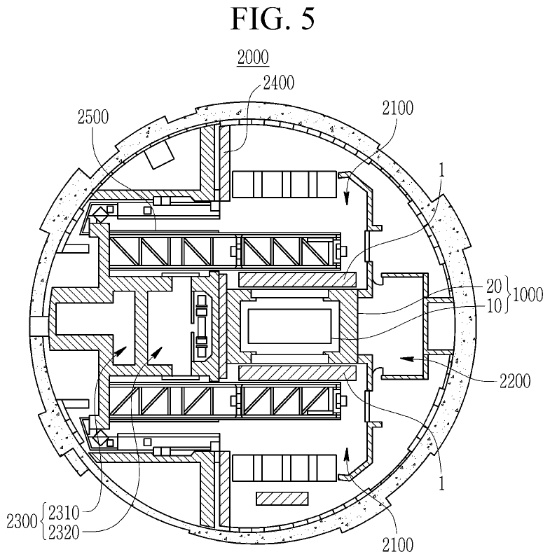

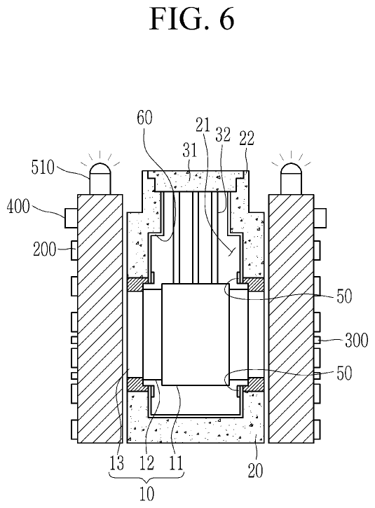

FIG. 4 is a top plan view of a state in which the exposure prevention apparatus for dismantling is installed in the heavy water reactor facility of a heavy water reactor according to the embodiment, FIG. 5 is a schematic perspective view of the exposure prevention apparatus for dismantling of the heavy water reactor facility according to the embodiment, and FIG. 6 is a cross-sectional view of a state in which the exposure prevention apparatus for dismantling is installed in a front side and a rear side of the calandria vault according to the embodiment.

As shown in FIG. 4, the heavy water reactor facility 1000 may be installed in a central portion of a heavy water reactor 2000. However, the position of the heavy water reactor facility 1000 is not limited thereto.

The heavy water reactor 2000 may have a planar circular structure, and the heavy water reactor facility 1000 and various devices may be installed inside the heavy water reactor 2000 of the circular structure.

The heavy water reactor 2000 may include the heavy water reactor facility 1000 installed in the central portion thereof, a fuel replacement room 2100 that is adjacent to the heavy water reactor facility 1000, and a moderator room 2200. A fuel storage room 2300 may be disposed adjacent to the fuel replacement room 2100. In the fuel storage room 2300, a spent nuclear fuel transfer room 2310 and a new fuel loading room 2320 can be installed.

A sliding gate 2400 is installed between the fuel storage room 2300 and the fuel replacement room 2100 to adjust opening and closing between the fuel storage room 2300 and the fuel replacement room 2100.

The heavy water reactor 2000 has an operation type that periodically replaces nuclear fuel during light operation. Nuclear fuel is replaced through the front and rear of the calandria 10 using a fuel replacement device, and the sliding gate 2400 is closed during nuclear fuel replacement to control worker access.

The fuel replacement room 2100 communicates with the front and rear surfaces of the calandria vault 20 of the heavy water reactor facility 1000, respectively, and a fuel replacement device can be disposed therein. The fuel replacement device may move by using a fuel replacement rail 2500. The spent nuclear fuel is transferred to the fuel storage room 2300 using the fuel replacement device and fuel replacement rail 2500.

The moderator room 2200 is disposed at a side surface of the calandria vault 20 to supply a moderator to the calandria 10. In moderator room 2200, a pump for supplying the moderator to the calandria 10 and a heat exchanger for controlling a temperature of the moderator can be installed.

During operation of the heavy water reactor facility 1000, the fuel storage room 2300 and the fuel replacement room 2100 are blocked from each other by using the sliding gate 2400 while the heavy water reactor facility 1000 is running, thereby controlling the worker's access. In addition, in the case of nuclear fuel replacement, between the fuel storage room 2300 and the fuel replacement room 2100 is opened using the sliding gate 2400, and thus the nuclear fuel provided in the fuel storage room 2300 can be replaced using the fuel replacement rail.

The front and rear surfaces of the calandria 10 of the heavy water reactor facility 1000 are exposed to the outside for nuclear fuel replacement during operation of the heavy water reactor facility 1000. Accordingly, the front and rear surfaces of the calandria vault 20 corresponding to the exposed front and rear surfaces of the calandria 10 have openings.

When the nuclear power plant is dismantled, there is no fuel replacement device, and the sliding gate 2400 is open, thereby opening between the fuel storage room 2300 and the fuel replacement room 2100. Therefore, the worker can be exposed by the exposed calandria 10. In particular, when the heavy water reactor 2000 is dismantled, workers placed inside the heavy water reactor 2000 may be exposed to preferentially dismantle the surrounding structures disposed inside the heavy water reactor 2000 except for the calandria 10 and the calandria vault 20.

In order to prevent this, in the present embodiment, an exposure prevention device 1 for dismantling may be installed in the heavy water reactor facility 1000 inside the heavy water reactor 2000.

This will be described in detail with reference to the accompanying drawings.

As shown in FIG. 5, an exposure prevention device 1 for dismantling of the heavy water reactor facility according to the embodiment includes a shielding film 100, a plurality of radiation measuring instruments 200, a motion detector 300, a dose display unit 400, and a warning unit 500.

As shown in FIG. 6, before installing the exposure prevention device 1 for dismantling the heavy water reactor facility in the heavy water reactor facility 1000, the heavy water reactor facility 1000 is in a state that the reactor pipe 40 is separated from the calandria 10. That is, the heavy water reactor facility 1000 is in a state that the coolant feeder 41, the pressure tube 42, the calandria tube 43, and the end fitting part 44 are separated from the calandria 10.

As shown in FIG. 4 to FIG. 6, the shielding film 100 covers the front and the rear of the calandria vault 20. Such a shielding film 100 may be disposed between the fuel replacement room 2300 and the front and rear surfaces of the calandria vault 20, respectively. Therefore, since the front and rear surfaces of the calandria 10 exposed to the outside for raw material replacement can be blocked from the outside, it is possible to prevent the worker from being exposed to radiation. Since the shielding film 100 is formed larger than the side of the calandria 10, it can block most of the radiation.

The plurality of radiation measuring instruments 200 may be installed in the shielding film 100. The plurality of radiation measuring instruments 200 are disposed at the same interval to acquire information about radiation for each position of the front and rear surfaces of the calandria 10.

The motion detector 300 may be installed in the shielding film 100. In this case, the motion detector 300 may be installed between the plurality of radiation measuring instruments 200. The motion detector 300 is provided to detect worker approach within a certain distance. Therefore, the motion detector 300 can be installed in a lower portion of the shielding film 100 up to a height that can detect the motion of the worker.

Since the dose display unit 400 is installed in the shielding film 100 and connected to the radiation measuring instruments 200, the dose determined by the radiation measuring instruments 200 can be displayed in real time. Therefore, since the dose display unit 400 displays the dose in real time, it is possible to control the worker's access when there is a lot of radiation.

The warning unit 500 is connected to the motion detector 300, and a situation detected by the motion detector 300 can be warned to the worker. The warning unit 500 may be a warning light 510 for visual warning or a warning speaker 520 for audible warning. The warning unit 500 can control the worker's access using the warning light 510 or the warning speaker 520 when the worker approaches within a certain distance.

As described, the exposure prevention device 1 for dismantling of the heavy water reactor facility is formed to cover the front and rear of the calandria 10, and thus it is possible to minimize problems such as worker exposure and radiation leakage by the front and back surfaces of the calandria 10 exposed to the outside for nuclear fuel replacement.

Hereinafter, a method for dismantling the heavy water reactor facility illustrated in FIG. 1 to FIG. 4 using the exposure prevention device for dismantling the heavy water reactor facility illustrated in FIG. 4 to FIG. 6 will be described in detail.

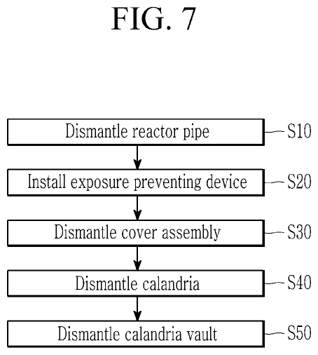

FIG. 7 is a flowchart of a heavy water reactor facility dismantling method of the heavy water reactor facility according to the embodiment.

First, as shown in FIG. 7, the reactor pipe 40 installed in the calandria 10 is dismantled (S10).

That is, the insulation material 90 that covers the surface of the end fitting part 41 exposed to the outside of the calandria 10 is removed. In addition, the coolant feeder 41 that supplies the coolant to the calandria 10 is removed. Then, the end fitting part 44 connected to the end shield 13 can be removed.

In addition, the pressure tube 42 that horizontally penetrates the calandria 10 and the calandria tube 43 that surrounds the pressure tube 42 can be removed. In this way, the risk of exposure and dismantling of workers can be minimized by removing the high-radiation pressure tube 42 and the calandria tube 43 in advance.

Next, the exposure preventing device 1 is provided at both sides of the calandria vault 20 (S20). The exposure prevention devices 1 are provided at both sides of the calandria vault 20 such that the front and the rear of the calandria 10 can be covered. Therefore, it is possible to minimize problems such as worker exposure and radiation leakage by the front and rear surfaces of the calandria 10 exposed to the outside for nuclear fuel replacement

Information about the radiation for each position on the front and rear of the calandria 10 can be acquired and informed to the worker in real time through a plurality of radiation measuring instruments 200 and a dose display unit 400 installed in the exposure prevention device 1, thereby minimizing the worker's exposure.

In addition, the exposure of workers can be minimized through the motion detector 300 and the warning unit 500 installed in the exposure prevention device 1.

Next, the cover assembly 30 installed in the calandria 10 and the calandria vault 20 is dismantled (S30).

That is, the reactivity mechanism deck 31, the upper guide tube 32, the side guide tube 33, the pressure relief pipe 34, and the moderator pipe 35 are removed from the calandria 10 and the calandria vault 20. Then, the internal structures such as the guide pipe 51 and the poisonous material injection pipe 52 disposed inside the calandria 10 are drawn out to the outside of the calandria 10 and dismantled.

Next, the calandria 10 is dismantled (S40).

Between the main shell 11 and the sub shell 12 of the calandria 10, the upper portion 22 of the calandria vault 20 is cut through, and the cut main shell 11 is drawn out to the outside of the calandria vault 20. In addition, the shielding slab 51 and the linear plate 60, which are internal structures of the calandria vault 20, can be removed. As shown in FIG. 2 and FIG. 3, the shielding slab 50 is installed at a boundary between the calandria vault 20 and the end shield 13, and the shielding slab 50 is provided to more completely shield radiation emitted from the calandria 10. The linear plate 60 is disposed in an inner wall of the calandria vault 20, and may be fixed to the calandria vault 20 by using an anchor. The liner plate 60 is installed on the entire inner wall of the calandria vault 20 to prevent leakage of light water filled inside the calandria vault 20. The liner plate 60 may be made of carbon steel.

Next, the calandria vault 20 is dismantled (S50).

The plurality of shielding balls 13c and the shielding water 13d dispersed in the end shield 13 illustrated in FIG. 3 can be removed. In addition, it is possible to remove an upper concrete slab and a lower concrete slab of the calandria vault 20 by using a cutting means such as a wire saw. Then, the end shield 13 can be removed.

As described above, by using the dismantling method of the heavy water reactor facility according to the embodiment, it is possible to minimize exposure of the worker and radiation leakage due to the calandria vault 20 and calandria 10, which is received in the calandria vault 20 and a highly radioactive structure.

While this invention has been described in connection with what is presently considered to be practical embodiments, it is to be understood that the invention is not limited to the disclosed embodiments. On the contrary, it is intended to cover various modifications and equivalent arrangements included within the scope of the appended claims.

1. An exposure prevention device for dismantling a heavy water reactor facility, comprising:
a shielding film that covers a front surface and a rear surface of a heavy water facility including a calandria and a calandria vault that accommodates the calandria;
a plurality of radiation measuring instruments installed in the shielding film; and
a motion detector installed in the shielding film.

2. The exposure prevention device for dismantling the heavy water reactor facility of claim 1, wherein
the heavy water reactor facility is provided in a central portion of a heavy water reactor, and
the heavy water reactor comprises:
a fuel replacement room that communicates with a front and a rear of the calandria vault of the heavy water reactor facility, respectively, and replaces fuel; and
a moderator room that is disposed at a side of the calandria vault and supplies a moderator to the calandria, and
the shielding film is disposed between each of the front and the rear of the calandria vault and the fuel replacement room.

3. The exposure prevention device for dismantling the heavy water reactor facility of claim 1, further comprising a dose display unit that is provided in the shielding film and displays a dose determined by the radiation measuring instruments.

4. The exposure prevention device for dismantling the heavy water reactor facility of claim 1, further comprising a warning unit that is connected to the motion detector, and warns a worker of a situation detected by the motion detector.

5. A method for dismantling a heavy water reactor facility that includes a calandria including a main shell and a sub shell, a calandria vault that receives the calandria therein, a reactor pipe including a pressure tube that horizontally penetrates the calandria, a calandria tube that surrounds the pressure tube, and a cover assembly that is provided in the calandria vault, comprising:
dismantling the reactor pipe provided in the calandria;
installing an exposure preventing device in a front and a rear of the calandria vault;
dismantling the cover assembly that covers the calandria;
dismantling the calandria; and
dismantling the calandria vault.

6. The method for dismantling the heavy water reactor facility of claim 5, wherein
the calandria further comprises an end shield that is connected to the sub shell, and
the dismantling of the reactor pipe comprises
removing a coolant feeder that supplies a coolant to the calandria,
removing an end fitting part connected to the end shield, and
removing the pressure tube and the calandria tube.

7. The method for dismantling the heavy water reactor facility of claim 6, wherein
the cover assembly comprises a reactivity mechanism deck that is supported by an upper portion of the calandria vault and covers the calandria, an upper guide tube that is vertically connected to the calandria, a side guide tube that is horizontally connected to the calandria, a pressure relief pipe connected to the upper portion of the calandria, and a moderator pipe that is connected to a lower portion and a side surface of the calandria and through which a moderator flows, and
the dismantling the cover assembly comprises
dismantling the upper guide tube,
dismantling the side guide tube,
removing the pressure relief pipe,
removing the moderator pipe, and
removing the reactivity mechanism deck

8. The method for dismantling the heavy water reactor facility of claim 7, wherein
the exposure prevention device comprises
a shielding film that covers opposite sides of the calandria vault,
a plurality of radiation measuring instruments installed in the shielding film, and
a motion detector installed in the shielding film.

9. The method for dismantling the heavy water reactor facility of claim 8, wherein
a dose by the radiation measuring instruments is displayed by using a dose display unit installed in the shielding film.

10. The method for dismantling the heavy water reactor facility of claim 9, wherein a situation detected by the motion detector is warned to a worker by using a warning unit connected to the motion detector.
